(19) United States
(12) Patent Application Publication
(10) Pub. No.: US 2008/0250925 A1
(43) Pub. Date: Oct. 16, 2008

(54) Sorption Element

(76) Inventors: Horst Egger, Villach (AT); Olaf Schwandt, Penk (AT)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 10/596,472

(22) PCT Filed: Dec. 15, 2004
(86) PCT No.: PCT/AT2004/000442

§ 371 Date: Feb. 6, 2008

(30) Foreign Application Priority Data
Dec. 15, 2003 (AT) A 2013/2003

(51) Int. Cl. B01D 53/12

(52) U.S. Cl. 95/26; 96/150; 96/133; 96/125; 95/113; 95/108

(57) ABSTRACT

The invention relates to a sorption element for a sorption-supported air conditioning unit for the humidification and/or heating and/or cooling of a room or an airflow. According to the invention, the heat and material transfer may be improved with a reduction in the size of the embodiment, variable amounts of the employed sorption agent and increased resistance to over-saturation, whereby the sorption element is embodied as a tubular piece with a tubular cross-section with a first and an opposing second open end with a first air-permeable grid element (23), defining the first open end and a second air-permeable grid element (14), defining the second open end thereof, whereby the grid elements do not permit a sorption agent to pass.

### BACKGROUND OF THE INVENTION

The invention relates to a sorption element for a sorption-supported air conditioning unit for heating and/or cooling and/or dehumidification of a room or an airflow.

Sorption elements are the central components in air conditioning systems of this kind and are generally used for air conditioning and/or dehumidifying comfort areas, especially office and living rooms, industrial rooms, or for process airflows frequently used in industry.

A known embodiment of a sorption element is the sorption wheel. Chambers are formed in the same along the circumference in which a carrier material for a sorption agent is located. The carrier material mostly consists of cellulose and comes with a honeycomb-like structure, thus ensuring a favorable ratio between material and surface and mechanical stability. Conventional sorption agents are silica gel, hygroscopic salts, especially LiCl or LiBr, molecular sieves or hygroscopic metal oxides, especially Al₂O₃.

The principle of adsorption is based on the fact that the above substances dehumidify an airflow, with the released heat of evaporation heating the airflow. This process is reversible, which is known as desorption, and is therefore also used for regenerating the sorption agents.

Sorption wheels rotate continuously about their longitudinal axis and are subjected in this process in different sections permanently by two different airflows. One airflow supports the desired air conditioning, whereas a second respectively prepared airflow ensures the regeneration of the chambers not currently used for air conditioning and thus prevent oversaturation of the sorption material.

The disadvantageous aspect is that as a result of the permanent fluctuations in humidity and temperature, sorption agent will detach from the carrier material. This effect in combination with the frequently occurring oversaturation frequently leads to the destruction of the carrier material.

A further disadvantage is that as a result of the honeycomb-like structure of the carrier material sorption wheels have a complex configuration and thus can only be produced with considerable effort. The sorption agent on the surface of the honeycomb-like structure further does not show optimal heat and material transfer. This and the proportional connection between the quantity of the sorption agent and its saturation lead to embodiments with large volumes. The system can thus only be scaled within limits and is further limited in the control area.

### SUMMARY OF THE INVENTION

It is therefore the object of the present invention to provide a sorption element with which the above disadvantages can be avoided, the heat and material transfer is optimized, the construction sizes that can be technically realized are reduced, the useable quantity of the sorption agent is variable, and the endurance in the case of oversaturation can be increased.

This is achieved in accordance with the invention in such a way that the sorption element is configured as a tubular piece with a tubular cross section and with a first and an opposite second open end, whose first open end is delimited with a first air-permeable grid element and whose second open end is delimited with a second air-permeable grid element, with the grid elements being impermeable for a sorption agent.

As a result of this configuration, the sorption agent can be introduced between the grid elements without any help of a carrier material. A random accumulation by loose filling of the sorption agent in the sorption element offers the respectively subjected airflow with an especially large acting specific surface during the flow through the same, leading to a higher flow resistance. Heat and material transfer is thus improved, thus leading to an efficient adsorption and desorption behavior. Since the sorption agent is arranged as a loose fill, the advantage is gained that the possibilities for influencing an increase of the heat and material transfer and the increase of the specifically acting surface can be utilized.

Since the sorption agent is filled up to a height which is lower than the length of the sorption element, it is thus ensured that swirling is allowed to expand spatially. This embodiment further offers the possibility to adjust the quantity of sorption agent to the respectively desired air conditioning. This is advantageous because this also increases the scaleability and thus also the controllability.

The sorption agent can be fluidized/swirled by an airflow, especially coming from below. It is advantageous in this respect that the specific acting surface of a fluidized bed is substantially higher than in the case of a homogeneous cross flow of a loose fill or even a conventional sorption wheel with carrier material. This leads to a further increase in the heat and material transfer.

According to a preferred embodiment of the invention it can be provided that the sorption element has a substantially circular cross section. This advantageously ensures that a geometry is present for the respective airflow which is optimal from the standpoint of flow technique and thus an even distribution of the cross-flow can be achieved. Furthermore, the input of material for the sorption element is low as a result of the circular cross section.

A variant of the invention can be that the sorption element has a substantially polygonal, especially rectangular cross section. Production costs for a sorption element can thus be reduced. Further advantages are shown in the costs for packaging, storage, transport and the possibility of simple mounting.

It can be provided for in a further embodiment of the invention that the first open end and/or the second open end is smaller than the tubular cross section. The advantageous effect is obtained here in that the reduction of the cross section can act like a nozzle. This ensures that the sorption agent can be subjected to an airflow in such a way that swirling occurs. The largest possible acting specific surface of the sorption agent is thus achieved, leading to improved heat and material transfer.

In a further development of the invention it can be provided that a maintenance opening is provided through which the sorption agent can be introduced into the sorption element and/or is exchangeable. This is advantageous because sorption agent can simply be refilled, removed or exchanged, if necessary. The maintenance opening further ensures that in the case of a contamination of the sorption agent, the same can be removed and cleaned or replaced easily.

One variant of the invention can be that the sorption agent comprises silica gel, a hygroscopic salt, especially LiCl or LiBr, a molecular sieve, hygroscopic metal oxide, especially Al₂O₃, or a combination of the above. This allows ensuring and/or setting the property of change of humidity which is necessary for sorption at a simultaneous change of temperature of the flowing medium.

In an embodiment of the invention it can be further provided that the sorption element is arranged in a substantially perpendicular fashion.

One variant of the invention can be that the sorption agent is arranged as a loose fill. This leads to the advantage that possibilities for influencing the increase in the heat and material transfer, the increase of the specific acting surface and the reduction of the flow speed can be utilized.

In a further development of the invention it can be further provided that in the case of a substantially perpendicular configuration of the sorption element the sorption agent can be filled up to a height which is lower than the length of the sorption element. It is thus ensured that swirling can expand spatially. This embodiment further offers the possibility to adjust the quantity of the sorption agent to the desired air conditioning. This is advantageous because thus the scalability and thus controllability are increased.

In a further development of the invention it can be provided that the sorption agent can be fluidized/swirled by an airflow, especially coming from below. It is advantageous that the specific acting surface of a fluidized bed is substantially higher than in the case of a homogeneous cross flow of a loose fill or even a conventional sorption wheel with carrier material. This leads to a further increase in the heat and material transfer.

The invention further relates to a sorption system for a sorption-supported air-conditioning unit for dehumidifying and/or heating and/or cooling a room or airflow.

A known sorption system is the sorption wheel with carrier material onto which the sorption agent is applied.

The disadvantage of this system is that asia result of the frequent fluctuations in temperature and humidity the sorption agent will detach from the carrier material and the same will be destroyed as a result of water precipitations, especially after several cases of oversaturation. Additional factors are large embodiments as a result of adverse efficiency. As a result, the system is scalable only within limits and the control range is thus limited.

It is the object of a sorption system to avoid the above disadvantages and to further develop the system in such a way that it is profitable at acceptable overall sizes and can be operated continuously and is provided in a respective controllable configuration.

This is achieved in accordance with the invention in such a way that the sorption system comprises at least two substantially parallel extending sorption elements according to the invention. The advantage is that as a result of spatial closeness of the sorption elements alternating subjection to conditioning and/or regeneration airflow can be realized in a simple manner without decisively influencing the size of the constructional configuration.

According to a further embodiment it can be provided that the sorption system is rotatable about an axis substantially parallel to the longitudinal axis of the sorption system and/or is movable normal to its longitudinal direction. This advantageously ensures that the supply and/or discharge of the different airflows can be provided in a rigid manner. The subjection of the individual sorption elements occurs by movement of the sorption system itself and thus substantially simplifies technical implementation.

The invention further relates to a method for a sorption-supported air-conditioning unit for dehumidifying and/or heating and/or cooling a room or an airflow with a sorption element according to the invention, optionally a sorption system according to the invention.

Known methods in air-conditioning technology are the use of refrigerating machines such as compression refrigerators, the dehumidification by falling below the dew point with the help of refrigeration cycles and the known method of evaporative cooling.

The disadvantageous aspect is that these methods can only be realized with a high amount of electrical effort and thus high system costs are incurred. Further costs are incurred by adverse long-term behavior and the thus required high amount of maintenance. A further disadvantage is the adverse environmental compatibility of the known systems because they can only be operated by using ecologically doubtful and/or toxic refrigerating agents which need to be disposed of specially. These disadvantages are the reason that sorption-supported air-conditioning systems are currently only operated in test systems and cannot be used commercially.

It is the object of the invention to provide a method for air-conditioning with which the mentioned disadvantages can be avoided, especially concerning the economic and ecological weak points such as the omission of toxic refrigerating agents, increase in the service life, increase in the operational security and lowering the operating costs.

This is achieved in accordance with the invention in such a way that the airflow to be conditioned is guided through at least one of the sorption elements in a conditioning cycle, with the airflow to be conditioned being dehumidified. In this manner, heat is obtained in addition to the dehumidification of an airflow according to the principle of sorption, which heat will be used directly for heating a room and/or an airflow or is recirculated to the air-conditioning unit for increasing efficiency. The use of sorption elements according to the invention, and optionally sorption systems according to the invention, ensure increased operational security in combination with higher efficiency and reduced maintenance work.

In a further development of the invention it can be provided that after reaching a predetermined degree of saturation of the sorption agent in a regeneration cycle a regeneration airflow, and especially heated air, is guided through the at least one sorption element, and the conditioning cycle is started again after regeneration. This ensures that the property of adsorption of humidity of the sorption agent is restored again. The sorption agent can thus be used effectively again until the renewed reaching of the degree of saturation in the following conditioning cycle.

In a further embodiment of the invention it can provided that two or more sorption elements perform conditioning and regeneration cycles in a temporally staggered way with respect to each other. This ensures that the individual sorption elements are situated permanently in a conditioning and/or regeneration cycle and thus allow a continuous operation of the sorption system.

### BRIEF DESCRIPTION OF THE DRAWING

The invention is now explained in closer detail by reference to the enclosed drawings which show embodiments and process explanations, wherein:

FIG. 1 shows a sorption element in a plan and front view for illustrating a circular tubular cross section;

FIG. 2 shows a sorption element in a plan and front view for illustrating a square cross section;

FIG. 3 shows an embodiment of a sorption system in front view;

FIG. 4 shows a functional diagram of sorption-supported air-conditioning in a cyclic process;

FIG. 5 shows a functional diagram of a sorption-supported air-conditioning in a continuous process.

### DETAILED DESCRIPTION OF PREFERRED EMBODIMENTS

The principle of sorption is known by two phenomena, namely adsorption and desorption. In the case of adsorption, an airflow flowing over a sorption agent is dehumidified, with the same heating up as a result of the originating heat of evaporation. This effect is used in a sorption-supported air conditioning system in the conditioning cycle. Adsorption is reversible, which is then called desorption. Desorption is used in such a way that a sorption agent saturated with humidity is subject to hot air, with the sorption agent thus being dehumidified. This process also occurs in sorption-supported air conditioning systems, namely in the regeneration cycle. The technical implementation occurs in a sorption element 1 which can be used both in the conditioning as well as the regeneration cycle.

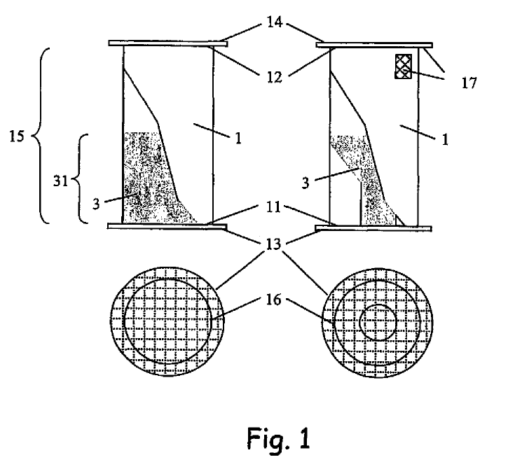

FIG. 1 shows an embodiment of a sorption element 1 with circular tubular cross section 16. The relevant aspect is that the sorption element 1 is configured as a tubular part whose open ends 11 and 12 are each provided with a grid element 13 and 14. The main feature of the grid elements 13 and 14 is however that they are impermeable for a sorption agent 3, without considerably influencing the flow of the airflow. The embodiment of the grid elements 13 and 14 is determined by the choice of the sorption agent 3. The sorption agent 3 is usually configured as a granulate most relevant feature in addition to the material itself is the grain size. The larger the grain size of the sorption agent 3, the wider the meshes can be in the grid elements 13 and 14.

The choice of the material used for the grid elements 13 and 14 also depends on the condition of the sorption agent 3 and the medium flowing through the same. The relevant aspect is that the grid elements 13 and 14 show chemical and mechanical endurance. Chemical resistance against oxidation in particular is a fundamental requirement for ensuring long-term operation. Possible further chemical reactions which influence the operation of the air conditioning system such that the quality of the airflow to be conditioned is influenced must also be prevented. Depending on the quantity of the sorption agent 3, the mechanical configuration of the grid elements 13 and 14 can be different. It is possible that in the case of smaller sorption elements 1 the grid elements 13 and 14 are arranged as a textile material part stretched over a frame, whereas in the case of large sorption elements the grid elements 13 and 14 can be arranged as a wide-meshed screen which is supported by a suitable mechanical construction.

The relevant aspect is also the type of fastening of the grid elements 13 and 14 to the respective tubular part. It is thus possible that the grid elements 13 and 14 are fastened with easily detachable connecting elements to the tubular part. They can be arranged as screwed joints, clamped joints, spring devices such as springs, belts or straps. Detachable connecting elements are especially useful in adjusting air conditioning units, because the open ends 11 and 12 of the tubular part are easily accessible and thus facilitate the introduction, refilling or exchanging of the sorption agent 3. A maintenance opening 17 can thus be realized.

When the grid elements 13 and 14 are mounted with a connecting method which can be detached only within limits or not at all, e.g. by riveting, welding, soldering or gluing, which can be applied in larger units, it is necessary to provide an alternative possibility for introducing the sorption agent 3. It is possible to provide an easily accessible maintenance opening 17 which is easy to open and close. A configuration is possible in the form of a flap with a respective lock or screwable cover in the upper region of the sorption element which is usually used in an upright position.

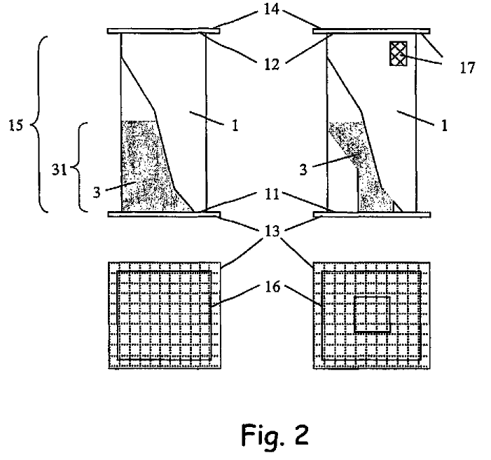

FIG. 2 shows a further possible tubular cross section 16 in a square. Depending on the configuration of the sorption element 1, the tubular cross section 16 can also be implemented in other polygonal geometries, especially in rectangles of a large variety of side ratios. Such embodiments are possible in air conditioning units with predetermined available space. This may be the case in units in which the support by a sorption element 1 will be installed as a retrofit.

The FIGS. 1 and 2 show that the sorption agent 3 is not introduced over the entire length 15 of the sorption element. The quantity of the sorption agent 3 can thus be adjusted to the requirements of the air conditioning unit.

The sorption agent 3 is introduced through the maintenance opening 17 which can be provided separately or can be integrated in the grid elements 13 and 14. The relevant difference to the previously known methods is the manner in which the sorption agent 3 is introduced into the sorption element 1. Whereas previously complex carrier material was used to which the sorption agent 3 is attached, the sorption agent 3 is introduced within the terms of the invention as a loose fill into the sorption element 1. With the same configuration size it is thus possible to introduce more sorption agent 3, which offers the considerable advantage that the entire surface of the sorption agent 3 is used for heat and material transfer, which is in contrast to previously used sorption elements which entail a surface loss by joining with the carrier material. The specific acting surface of the sorption agent 3 is thus increased and a functional failure due to destruction of the carrier material caused by oversaturation for example can be excluded.

The sorption element 1 can be subjected to airflows of different flow directions and speeds. The difference between the length 15 of the sorption element 1 and the height 31 of the loose fill of the sorption agent 3 form a chamber. It acts as a calming chamber in which the airflow that has already flowed through the sorption agent 3 can homogenize in order to supplied thereafter as a laminar flow through the second grid element 14 to the air conditioning process. A further function of the chamber is that in the case of a reversed flow the airflow distributes homogeneously over the tubular cross section 16 and flows through the sorption agent 3 only then. The air flow utilizes the entire cross-sectional surface. A further possible utilization of the chamber can be that it offers space for swirling at high flow speeds of the applied airflow.

The illustrations 1 and 2 show in the respective pictures on the right side possible embodiments of the sorption element 1 in order to achieve the effect of swirling. The necessary increase of the flow speed is achieved by reducing the tubular cross section 16. The advantage of this flow method is that the same, in comparison with the homogeneous flow through a loose fill, leads to an additional enlargement of the specifically acting surfaces and the heat and material transfer is increased additionally.

Sorption agents 3 used are silica gel, hygroscopic salts, especially LiCl or LiBr, a molecular sieve, a hygroscopic metal oxide, especially Al₂O₃, or a respective combination. It is possible that the sorption agent 3 which is usually provided as a granulate is used in different grain sizes. As a result, a ratio of surface to mass of the chosen sorption agent 3 which is adjusted to the unit can be used.

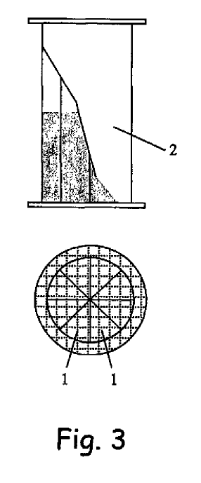

FIG. 3 shows a possible embodiment of a sorption system 2, namely a sorption wheel with sorption elements 1 in accordance with the invention. A sorption system 2 consists of at least two parallel extending sorption elements 1 which are isolated from one another and which are subjected simultaneously, but diametrically opposed, with different airflows. In FIG. 3, the sorption system 2 comprises eight sorption elements 1. Conditioning and regeneration cycle can thus occur at the same time and thus allow a continual support of the air conditioning unit. The sorption wheel rotates about its longitudinal axis, with sorption elements 1 arranged on the circumference being moved past the different airflows. This principle is easy to realize because the feed and discharge lines of the airflows can be provided with a rigid configuration.

A further possible system for the continuous operation can be achieved by translation of the parallel extending sorption elements 1 normal about its longitudinal axis. This is necessary when the parallel extending sorption elements 1 are arranged linearly next to one another.

Combinations of rotation and translation are possible when the sorption elements 1 are provided with a matrix-like configuration. A possibility for realization can be the use of a guided rotating chain.

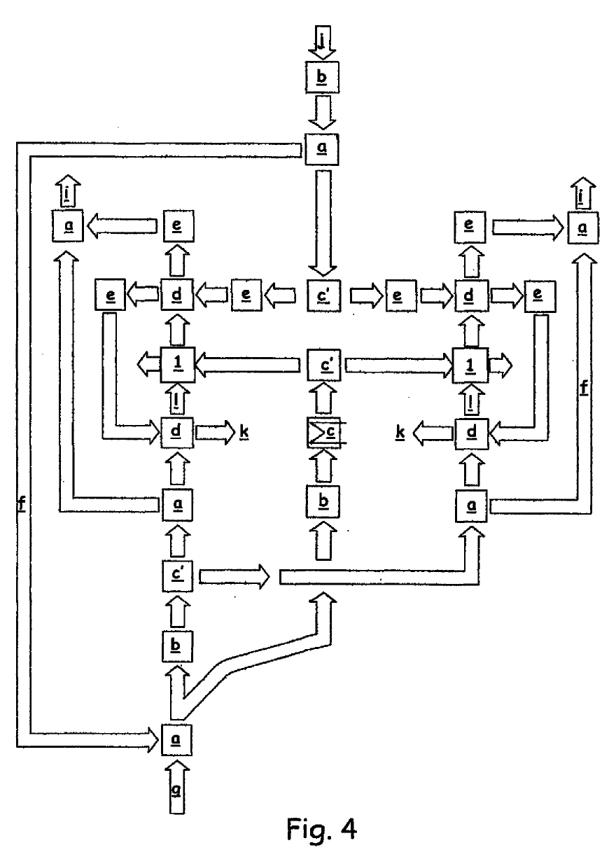

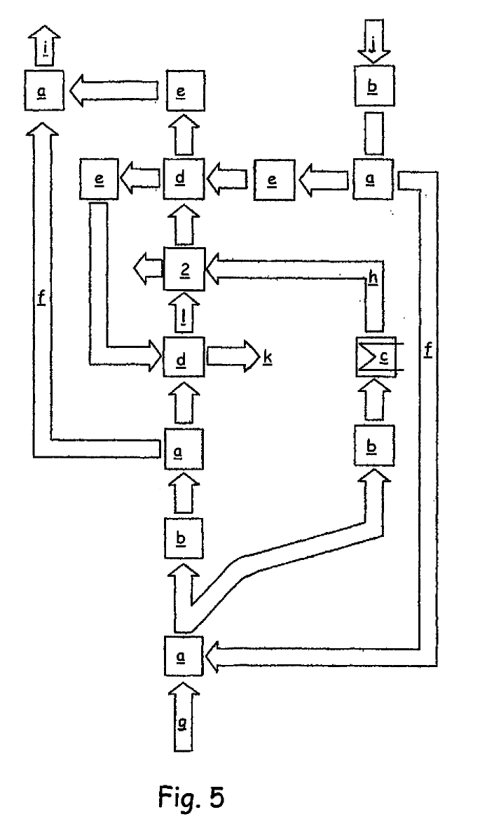

FIGS. 4 and 5 show two different operating methods for the permanent support of an air conditioning unit. The following nomenclature applies for explanation purposes in the two figures:
a Distributor
b Blower
c Heat exchanger
c′ Changeover between the different trains
d Heat exchanger
e Injection
f Bypass
g Fresh air
h Regeneration air
i Feed air
j Discharge air
k Escaping air
l Conditioning air

FIG. 4 shows a cyclic method. The core element of this method is formed by two separate, spatially separated sorption elements 1. While one sorption element 1 works in the conditioning cycle, the other is in the regeneration cycle. Regeneration occurs at higher temperatures and thus progresses faster. Once the sorption element 1 working in the conditioning cycle reaches a defined limit value of saturation with water, regeneration airflow and conditioning airflow are exchanged by changeover of train c′. After the changeover, the saturated sorption element 1 is subjected to regeneration air and the regenerated sorption element 1 to conditioning air. This alternating changeover allows a continual support of the air conditioning unit upon reaching a defined saturation limit.

FIG. 5 shows the continual method. The core element is formed by the sorption wheel. The characterizing elements in this method are the rigidly arranged feed and discharge lines of regeneration and conditioning airflow. The airflows are applied by rotation of the sorption wheel, i.e. the joined but isolated sorption elements 1 are turned into the respective airflow. The feed and discharge lines of the airflows are configured in such a way that a sorption element 1 is permanently situated in the conditioning cycle and a second sorption element 1 in the regeneration cycle, as a result of which a continual support of the air conditioning unit can be ensured.

A simple example of the functionality of a sorption element 1 or sorption system 2 is the dehumidification of the discharged air of a swimming pool for example. The discharged air j is guided through a sorption element 1 in the conditioning cycle, with the airflow being dehumidified and the same being heated up by the released heat of evaporation. This heated and dried airflow can now be directed back to the indoor swimming pool, as a result of which heating costs can be reduced considerably.

If certain temperatures or a final humidity are to be reached, the airflow i can be cooled by heat exchangers c and d. The preliminary humidification of the airflow by injecting water e further lowers the temperature and additionally offers the possibility to achieve certain air humidity. As required, temperature and humidity of an airflow i can thus be set in a purposeful manner. A changeover from winter to summer operations can thus be realized easily, such that heat exchanger or injection units c, d and e are passed by with by-passes f, or that they are flowed through without cooling. The sorption element 1 can thus remain in the system for the whole year. A relevant advantage of the sorption-supported air conditioning systems is that the sorption elements 1 can be combined with all tested humidifying systems, external cooling systems or alternative heat sources, especially solar heat, waste heat from industry, condensation heat from refrigerating systems and combined heat and power generation systems.

1-26. (canceled)

27. A sorption element for a sorption-supported air conditioning unit for heating and/or cooling and/or dehumidification of a room or an airflow, comprising:
a tubular body defined by a cross section and having opposite first and second open ends;
a first air-permeable grid element delimiting the first open end and impermeable for a sorption agent; and
a second air-permeable grid element delimiting the second open end and impermeable for a sorption agent,
wherein the sorption agent is arranged as a loose fill and filled up to a height which is smaller than a length of the tubular body, and
wherein the sorption agent can be fluidized or swirled by an airflow.

28. The sorption element of claim 27, wherein the airflow is introduced from below the tubular body.

29. The sorption element of claim 27, wherein the cross section of the tubular body is substantially circular.

30. The sorption element of claim 27, wherein the cross section of the tubular body is substantially polygonal.

31. The sorption element of claim 27 wherein the cross section of the tubular body is rectangular.

32. The sorption element of claim 27, wherein at least one of the first open end and second open end has a cross section which is smaller than the cross section of the tubular body.

33. The sorption element of claim 27, wherein the tubular body has a maintenance opening for allowing introduction or exchange of the sorption agent.

34. The sorption element of claim 27, wherein the sorption agent is a material selected from the group consisting of silica gel, hygroscopic salt, molecular sieve, hygroscopic metal oxides, and any combination thereof.

35. The sorption element of claim 34, wherein the hygroscopic salt is LiCl or LiBr.

36. The sorption element of claim 34, wherein the hygroscopic metal oxides includes Al₂O₃.

37. The sorption element of claim 27, wherein the tubular body is arranged in a substantially vertical disposition.

38. A sorption system for a sorption-supported air conditioning unit for dehumidifying and/or heating and/or cooling a room or an airflow, comprising at least two sorption elements disposed in substantially parallel relationship, each said sorption element including a tubular body defined by a cross section and having opposite first and second open ends, a first air-permeable grid element delimiting the first open end and impermeable for a sorption agent, and a second air-permeable grid element delimiting the second open end and impermeable for a sorption agent, wherein the sorption agent is arranged as a loose fill and filled up to a height which is smaller than a length of the tubular body, and wherein the sorption agent can be fluidized/swirled by an airflow.

39. The sorption element of claim 38, constructed for rotation about an axis in substantially parallel relationship to a longitudinal axis of the sorption system and/or for movement normal to a direction of the longitudinal axis.

40. A method for a sorption-supported air conditioning unit for dehumidifying and/or heating and/or cooling a room or an airflow, said method comprising the step of guiding the airflow to be conditioned in a conditioning cycle through a sorption element to thereby dehumidify the airflow to be conditioned.

41 The method of claim 40, further comprising the steps of guiding a regeneration airflow in a regeneration cycle through the sorption element, when a sorption agent reaches a predetermined degree of saturation, and subsequently restarting the conditioning cycle.

42. The method of claim 41, wherein the regeneration airflow is heated air.

43. The method of claim 41, wherein the step of guiding the airflow to be conditioned and the step of guiding a regeneration airflow involve the use of at least two sorption elements and are executed in a time-staggered manner.
